(19) United States
(12) Patent Application Publication
(10) Pub. No.: US 2010/0170643 A1
(43) Pub. Date: Jul. 8, 2010

(54) Device for the diversion of window coverings

(76) Inventors: James Anthony De France, Canton, MI (US); David Joseph De France, Howell, MI (US)

Correspondence Address: James De France, 45029 Coachman, Canton, MI, 48187, US

(21) Appl. No.: 12/350,263

(22) Filed: Jan. 8, 2009

(51) Int. Cl. E06B 9/00

(52) U.S. Cl. 160/127

(57) ABSTRACT

This device is designed to give added functionality to existing windows. It works by creating a usable space between the window pane and the user's chosen window covering, such as drapes, shades or curtains. The device interferes with the normal path a window covering would take, thus moving it away from the window pane. This is done by using one or more diverter pieces either attached to the window sill or pivoting out from the window frame which are shaped to allow smooth opening and closing of the window covering. The space between the covering and the pane could then be used by plants, pets or any other number of items, while maintaining privacy in the user's room.

### CLAIM OF PRIORITY

This utility patent application claims the priority from the provisional patent application titled “Device for the diversion of window coverings” filed Jan. 11, 2008.

### INTRODUCTION TO INVENTION

This invention relates to a window blinds or other window coverings diverter, specifically to allow users to lower horizontal window blinds or other window coverings to a fully lowered or closed position without interfering with objects resting on the window sill. And can also be used for vertical blinds and other window coverings.

Plant lovers would like many of their plants to have maximum sunlight and therefore placement on a window sill is common. Pet lovers would like to provide their pets with a place to relax in the sun at an elevated level where they can also look outside. These plant and pet lovers also would like to be able to close some sort of window treatment to secure privacy for the occupants or reduce incident light. The normal geometry of windows and blinds is not conducive to providing both without compromises in placement, size, closure degree or interference with the objects on the sill. This invention addresses these shortcomings by diverting the window covering to create a protected pocket on the sill while still allowing full and normal operation of the window covering.

### Relevant Prior Art

A search revealed no prior similar art.

### FIGURES

This provisional patent application contains the following drawings (8 pages):

FIG. 1 shows the left blind diverter installed on the left inner side of the window opening. It also shows the lowered blinds being diverted to a position interior of the standard window sill landing.

FIG. 2 shows the front view of the installed left blind diverter with slight offset from the wall to fully intercept the blinds travel. It shows the optional retaining/cross bar which provides a sight shield for the reduced vertical travel of the lowered blinds as well as a retainer to keep objects from falling off the sill.

FIG. 3 shows detailed features of the diverter. Shown is the right side.

FIG. 4 is a view showing a shoulder at the attachment point either integral or separate.

FIG. 5 shows a view of a concept of the edge formation to provide a smooth yet strengthening edge.

FIG. 6 shows a view of a channel concept for retaining the cross bar.

FIG. 7 shows an alternate view of a “T” shaped slot for retaining the cross bar.

FIG. 8 shows alternate embodiment to add access hole.

FIG. 9 shows a global view of alternative embodiment (the S Rod) with window blinds in raised position and device in upright/withdrawn position.

FIG. 10 shows a close-up view of pivot assembly and diverter arm in upright position. Note: various pivot and mounting geometries are possible.

FIG. 11 shows a global view of window blind in closed position and device in lowered/engaged position.

FIG. 12 shows a top view of device without diverter arm showing setoff from the side wall to accommodate various window moldings.

FIG. 13 shows a close up view of version of pivot device using friction to maintain diverter arm position with arm in upright position.

FIG. 14 shows a close up front view of friction pivot device with diverter arm in upright position. Note offset from window opening side ensures full interference with normal travel of blinds.

FIG. 15 shows a close up side view of version of pivot assembly with locator grooves.

FIG. 16 shows a close up side view of another potential version of assembly with detents.

FIG. 17 shows a front view of alternative embodiment of window diverter for horizontal moving window coverings.

FIG. 18 shows a top view of diverter for horizontal moving window coverings, showing interface of diverters with cross bar.

FIG. 19 shows a simplified top view of diverter for horizontal moving window coverings showing blinds (or curtains) diverted around the window sill.

### DESCRIPTIONS AND OPERATION

### Description of Basic Embodiment (#1) Left & Right Diverter Brackets

The basic version of the window blind diverters provides an increased cavity area to place items between the lowered blinds and the window pane. These items would then be in a position to obtain maximum sunlight exposure while the blinds are still down to provide shade and privacy to the room occupants. This would allow plants to be placed optimally.

The basic diverter could be made of a variety of materials and combinations including plastics, foams, metals, woods, ceramics or glass.

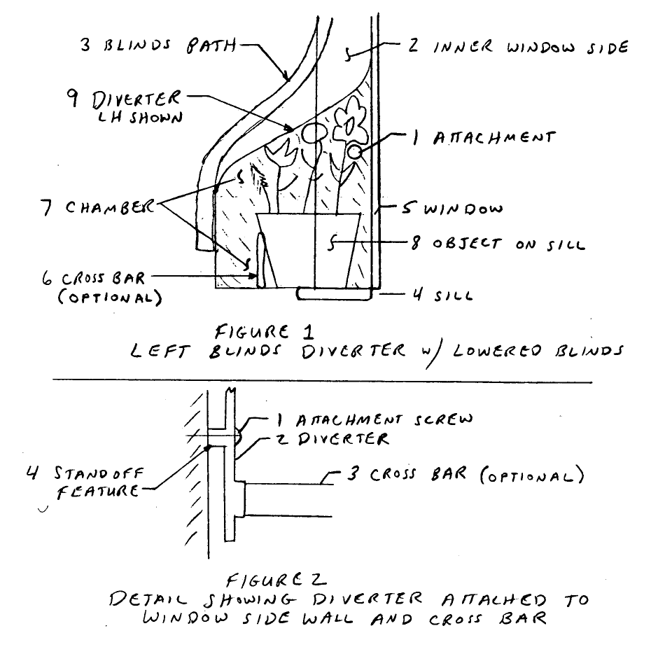

This version of the diverter uses left and right diverter brackets in a fixed mount to the existing window opening. See FIG. 1.

FIG. 1 of the basic version is a view of the left inner side 1.2 of a window 1.5 opening. The right inner side would be symmetrical. It shows the window blind diverter 1.9 in position which is fixed along with the one (or more) attachment screw(s) 1.1. The diverters extend beyond the path 1.3 of the normal travel of window blinds. It also shows the lowered blinds being diverted to a position interior of the standard window sill landing 1.4 to allow a larger chamber 1.7 on the window sill that is not impinged upon by the lowered blinds. It also shows the attachment of an optional retaining/cross bar 1.6 that also links with the right hand diverter to form a barrier that retains the object 1.8 on the sill. The retaining/cross bar is shown and described in more detail below in Figures: 2.3, 17.5, 18.6, 18.8 and 18.9.

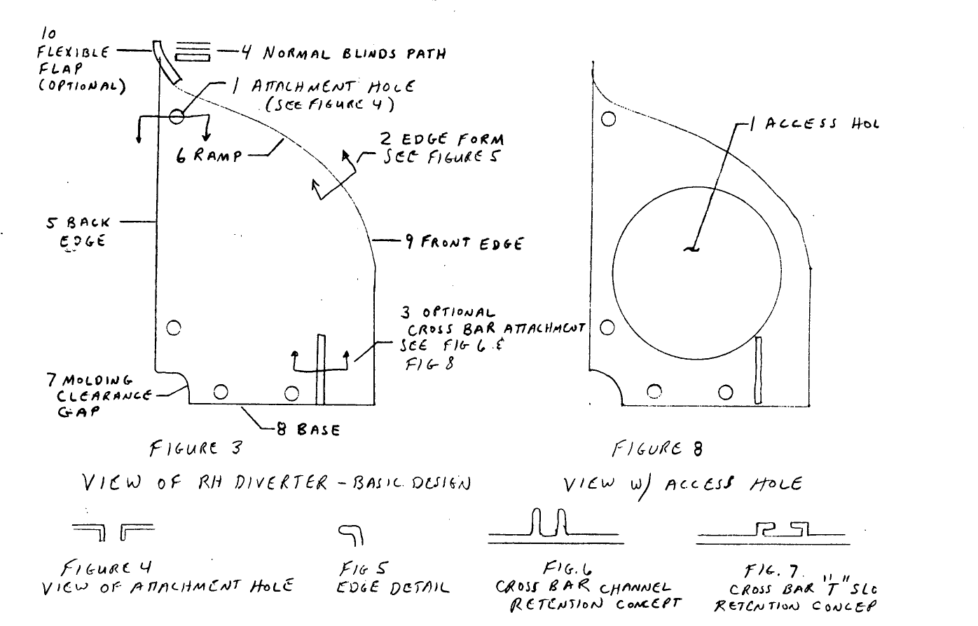

FIG. 2 of the basic version is a view showing the installed attachment screw(s) 2.1. Note the clearance provided by the stand off feature 2.4 to avoid scratching the wall surface and providing a more inboard position to preclude the blinds from falling off the diverter 2.2. A portion of the optional retaining/cross bar 2.3 is shown as well.

FIG. 3 shows a detailed view of the right (left is mirror image) diverter as a component with these features:

3.1 Attachment hole. Two or more provided to accommodate various window styles.

3.2 Edge form. This is the edge that allows the blinds to smoothly transition to an alternate path creating the protected cavity on the sill.

3.3 Attachment for the retaining/cross bar. This can be a channel, accommodate screws or other device of attachment. Note: many optional attachments are possible.

3.4 The diverter with normal interface with the blinds travel path.

3.5 Back edge which is parallel to window frame but may or may not be flush with the window's frame and may or may not be flush with the window pane.

3.6 Ramp. Shape (which can vary) to allow blinds to transition to new path.

3.7 Gap. To clear moldings which are sometimes installed to finish a window edge.

3.8 Base. Parallel to the sill surface. It may or may not be flush with the sill depending on desired cavity and any interferences.

3.9 Front edge. Allows the smooth raising and lowering of the blinds.

3.10 Optional flexible flap made of either plastic or rubber. The flap bridges any gap between the diverter and the window pane, ensuring that the window coverings do not get caught on the diverter.

FIG. 4 shows a view of the attachment hole with a standoff which can be integrated as shown, or a separate piece.

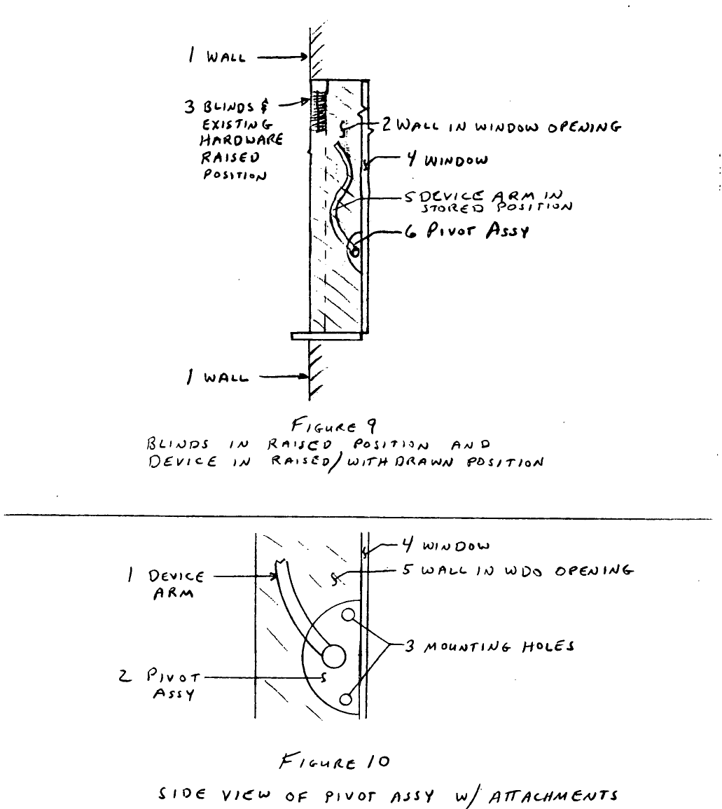

FIG. 5 shows a concept of the front edge with a curve to strengthen the diverter form and give more surface area for the window coverings to travel along.

FIG. 6 shows the detail of the channel that the retaining/cross bar will slide into.

FIG. 7 shows a variation of channel in FIG. 6 to include a “T” shaped slot. This design will prevent the variable length retaining/cross bar (as described more fully below) from coming loose from the diverter.

Operation of the Basic Diverter Embodiment

Flower pots are placed on the sill in stable position. Blinds or other window coverings are lowered to normal position. The diverter allows the window coverings to avoid hitting the objects on the sill while being raised or lowered. When the window coverings are in their lowered position, the objects on the sill are not disturbed and the occupants of the room can benefit from shade and privacy if desired.

If the optional retaining/cross bar is used it will cover any gap created by the window coverings not being long enough to reach the window sill. Thus privacy and shade will be maintained. Additionally, with retaining/cross bar, flower pots with larger base than the window sill will be retained allowing the user to have larger plants in the window than the sill would normally accommodate.

### Description of Alternative Embodiment (#2)—Basic Diverter with Access Hole

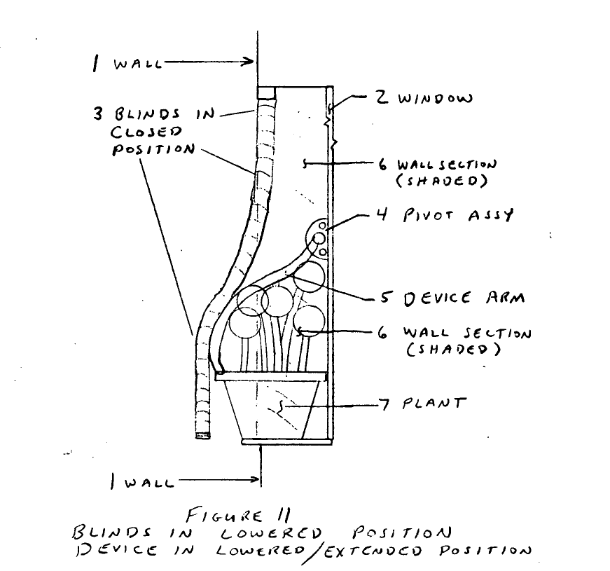

FIG. 8 shows the diverter as described in detail in FIGS. 1 through 7, with the addition of a hole in the side of the diverter 8.1. All other features remain the same.

### Operation of this Alternative Embodiment

The addition of a hole allows animals seeking to sit on a window sill to come and go as they please without the owner having to raise and lower the window coverings, while still providing the room occupants relative shade and privacy versus having the window coverings open. Additionally, this design could allow for easier watering or observation of plants on the window sill without having to open the window coverings.

### Description of Alternative Embodiment (#3)—The S Rod with Frictional Pivot

This version of the diverter sits fully within the frame of the window. See FIG. 9. The device consist of a pivot assembly 9.6 and a pivoting diverter arm 9.5.

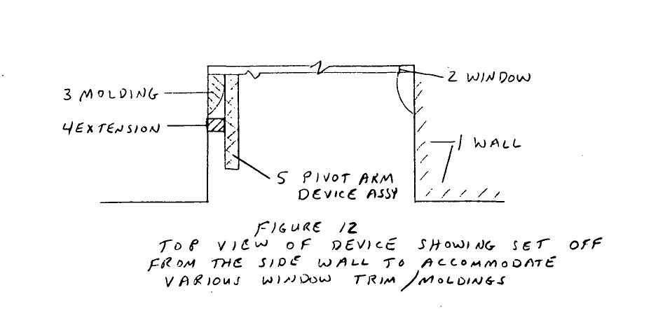

In FIG. 10, the pivot device is shown close up. The pivot assembly 10.2, made preferably of plastic or metal sits flush with the window 10.4, and is mounted to the adjoining wall 10.5 with screws driven through the two mounting holes 10.3. The diverter arm, preferably made of metal 10.1 is attached to the pivot assembly 10.2 and rotates on it.

FIG. 11 shows the diverter arm 11.5 in the lowered or outward position and shows the blinds 11.3 being pushed outward away from the window 11.2 and the plant on the window sill 11.7.

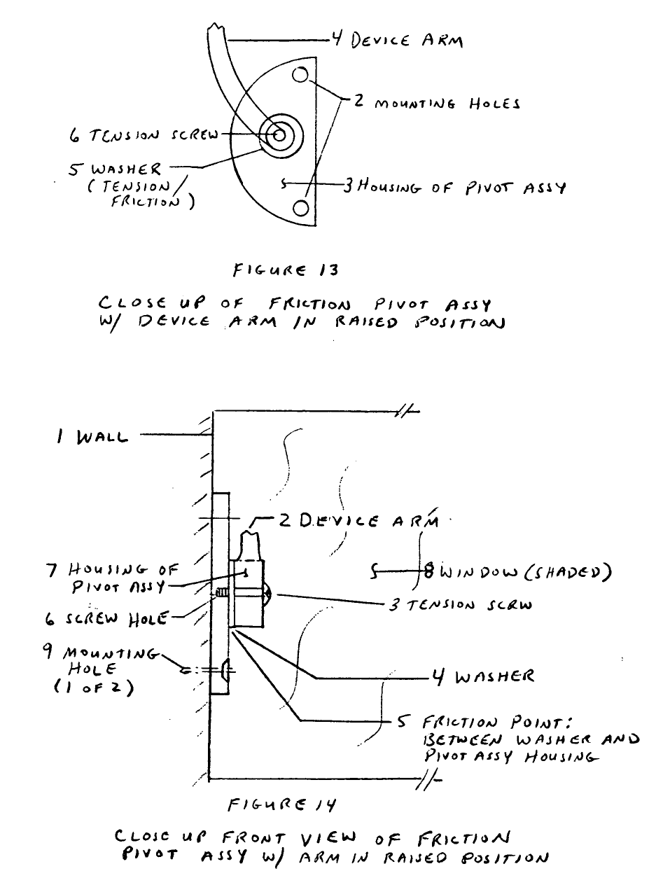

FIG. 12 shows a simplified top view of a typical pivot assembly without the diverter arm. Depending on the users particular window there may be molding 12.3 preventing the pivot assembly from being mounted flush with the wall 12.1. In this case, there will be a mounting extension piece 12.4 which will allow the assembly to be securely mounted and sit in from the edge of the window assuring that the window covering does not slide off of the pivot arm.

FIG. 13 shows one embodiment of the pivot assembly which uses friction to maintain the position of the diverter arm. The diverter arm 13.4 is attached to a washer 13.5. The washer is pressed against the device assembly 13.3 by use of a screw 13.6. The friction between the washer 13.5 and the assembly 13.3 prevents the diverter arm 13.4 from moving without human assistance.

FIG. 14 is a close up side view of the same friction based alternative embodiment showing how the pieces of the device fit together. Diverter arm 14.2 is attached to the washer 14.4 which is tightened into the device assembly 14.7 by the tension screw 14.3. The device assembly is then screwed into the wall 14.1 with screws driven through the mounting holes 14.9.

### Operation of this Alternative Embodiment

When the diverter arm is in its upright position it allows vertically moving window coverings to be either up (so the window is visible) FIG. 9, or in a closed position (where the window is not visible) without interfering with the window covering's operation. When the device is in its deployed or outward position, FIG. 11, it guides the window covering away from the window. In this way, it creates a gap between the window covering and the window. This gap can be used to keep things on the window sill such as plants, decorations or a place for pets to rest without the window covering being in the upright position. The device arm can be placed in one of many positions. This allows the gap between the window and the window covering to be variable depending on the size or height of the item you wish to be placed on the window sill. By doing this, the privacy of the interior of the room is not compromised. Additionally, the light from outside will not enter the room. Yet, an item, such as a plant can continue to take full advantage of daylight everyday without the owner having to reposition it or open and close the blinds when the owner desires less light or privacy.

### Description of Alternative Embodiment (#4)—The S rod with Detent Positions

The appearance of this alternative embodiment is substantially similar to the embodiment above. The functional and mechanical difference involves the use of detents as opposed to friction to determine the position of the diverter arm.

FIG. 15 shows once such possible embodiment of the device housing with grooved detents. The diverter arm would be held in a particular position by pre-formed grooves 15.4. The arm would snap into place in order to keep it in a secure position. This design would have at least two grooves: and upright/withdrawn position and an outward/deployed position. It is preferable for there to be other grooves as to allow for variability in the positioning of the arm. The device housing with detents could be made of metal, plastic, wood or any other rigid yet formable material.

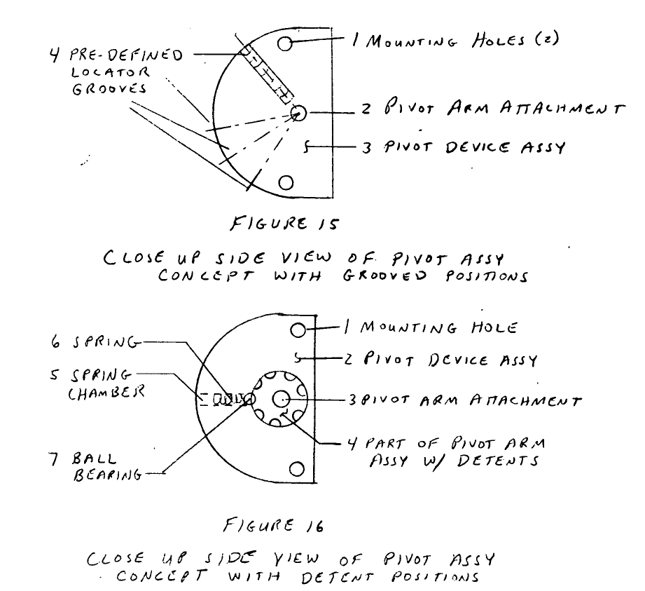

FIG. 16 shows another variety of the device housing with detents. This embodiment has the detents on the inside. The diverter arm assembly includes a wheel 16.4 with cut outs or dimples. Those dimples line up with a ball bearing or other spring forced component 16.7 which is pushed toward the dimples with a spring 16.6 which is in a channel/chamber 16.5. Depending on the specific design, the wheel 16.4 can be inside or outside the pivot assembly 16.2. This design allows for the diverter arm to be “locked” in any of a number of positions: upright and various degrees of outward or deployed positions. Metal or rigid plastic are the preferred materials to be used in the manufacture of the wheel in order to ensure its integrity over many position changes.

### Operation of this Alternative Embodiment

The operation of this embodiment is identical to the embodiment #3 described above. The only difference is the method used to hold the position of the diverter arm. The method of embodiment #3 above uses friction, this embodiment uses detents.

### Description of Alternative Embodiment (#5)—for Horizontal Moving Window Coverings

As not all windows are fitted with vertically moving coverings, an alternative design is necessary for horizontal moving (side to side) window coverings in order to provide the same benefit as the embodiments above.

FIG. 17 shows a simplified full front view of the horizontal device. Two curved diverters 17.4 are attached to the sides of the wall surrounding the window. These pieces 17.4 can be made of wood, plastic or metal depending on strength, weight and desired appearance of the product. Attaching to the two diverters is a horizontal bar 17.5 which extends in length to accommodate varied window sizes.

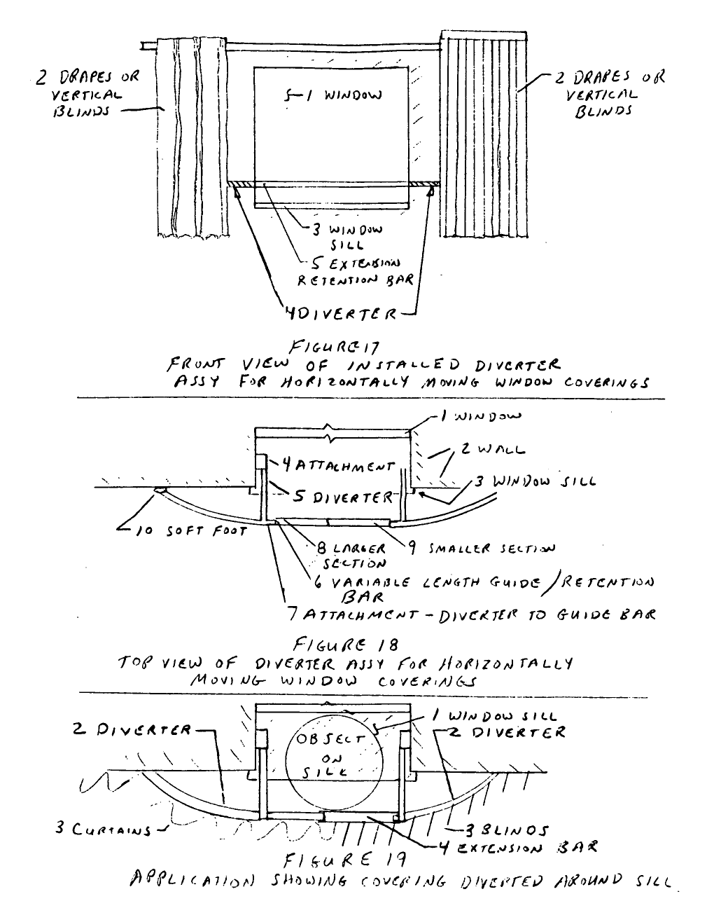

FIG. 18 shows a top view of the diverter for horizontal window coverings. The curved part of the diverter sits against the wall 18.2. Soft feet (can be rubber or another material) 18.10 are at the end of the curved portion of the diverter to prevent slippage on the wall and to prevent scratching or staining of the wall 18.2. The flat part of the diverter is attached to the inside of the wall surrounding the window. It is attached to the wall via screws or other fastener 18.4. The fastener can be moved closer to or farther from the window depending on the particular user's window to accommodate for variations such as moldings. Between the two diverters is the extension bar 18.6. The bar is preferably made of metal and consists of two cylinders, one larger 18.8, one smaller 18.9. The smaller cylinder screws into the larger cylinder to extend or shorten the overall length of the bar 18.6. The ends of the bar 18.6 sit in pre-formed slots in the diverters 18.7. By extending the bar to the correct length, it will not come unattached from the curved diverters.

Alternatively, the bar can be two or more pieces of metal, consisting of at least one larger and one smaller but not threaded. The smaller piece will slide in and out of the larger piece to determine the appropriate length. The length will be maintained by the ends of the bar snapping in to place on the left and right diverters. Since the diverters are mounted and stationary, the bar will maintain the appropriate width without being threaded.

FIG. 19 shows a simplified top view of the diverter for horizontal moving window coverings with window coverings in the closed position. The blinds 19.3 are diverted outward/away from the window by the curved diverters 19.2. The blinds continue to be held away from the window by the extension bar 19.4 and then are guided back toward the wall on the other side of the window by the other diverter 19.2.

### Operation of this Alternative Embodiment

The function of this embodiment of the diverter is to allow for plants, decorations or animals to take full advantage of a window sill and the natural light from outside without having the user have to open and close the window covering if it is not desired. The curved diverters guide the window covering around the sill and the extension/retention bar serves several functions. First, it operates to keep the window covering away from the window, ensuring that the gap created by the diverter is consistent and usable throughout the entire width of the window. Second, by being variable in length, it allows the diverters to function properly on many different sized windows. Third, the extension bar also acts as a retention bar allowing an effective extension of a window sill. If the user wants to have a plant in the window whose base of the pot is wider than the sill, it will fall off the sill unless it is held in place. The extension/retention bar will keep the plant on the sill even if its base is wider than the sill.

What is claimed is:

1. A device which diverts the normal path window coverings, such as blinds or curtains, would move in, creating an enlarged space between the window pane and the window covering, comprising of:
a. one or more diverters made of rigid pieces of material
b. said diverters to be shaped as to provide guidance of a window covering away from the pane of the window
c. a means to secure said diverters in a position with respect to the window pane
d. such device as described above to be positioned in a particular manner according to whether the window covering moves vertically or horizontally,
whereby, when closing a window covering with said device installed a useful gap is created between the window covering and the window pane.

2. The diverter in claim 1 to be of sufficient size to create a wider space between the window covering and the window pane than exists without the device.

3. The diverter in claim 1 to be made of material rigid enough to maintain its shape and withstand the pressure that a window covering would place upon it.

4. The device in claim 1 to be secured in position by friction and gravity.

5. The device in claim 1 having means to be secured to the wall or the window sill with fasteners.

6. The method of fastening in claim 5 to allow the device to be moved.

7. The device in claim 1 having an optional retention bar of variable length.

8. The device in claim 1, installed in a manner for horizontally moving window coverings having an variable length horizontal bar to prevent the window coverings from catching on the device.

9. A device which diverts the normal path window coverings would move in, creating an enlarged space between the window pane and the window covering, comprising of:
a. one or more diverters made of rigid elongated pieces of material
b. said elongated diverters to be shaped as to provide guidance of a window covering away from the pane of the window
c. a means to secure said elongated diverters in a position with respect to the window pane
d. such device as described above to be positioned in a particular manner according to whether the window covering moves vertically or horizontally,
whereby, when closing a window covering with said device installed a useful gap is created between the window covering and the window pane.

10. The elongated diverters in claim 9 to be made of material rigid enough to maintain its shape and withstand the pressure that a window covering would place upon it.

11. The elongated diverters in claim 9 to be of sufficient length to create a wider space between the window covering and the window pane than exists without the device.

12. The elongated diverters in claim 9 to be shaped in a manner sufficient to allow the window coverings to slide along them with gravity alone as the window coverings are closed.

13. The elongated diverters in claim 9 to be shaped in a manner to allow the window covering to be re-opened without said diverters hindering the window covering's path of travel.

14. The elongated diverters of claim 9 having a means to be fastened to the window or the surrounding wall.

15. The fasteners of claim 14 having the ability to pivot.

16. Said pivoting fasteners of claim 15 being able to be variably positioned to create a larger or smaller space between the window pane and the window covering.

17. Said pivoting fasteners of claim 15 allowing the elongated diverters to be positioned parallel with the window pane so as not to interfere with the normal operation of the window covering.

18. Said pivoting fasteners of claim 15 to maintain the position of the elongated diverters by using friction.

19. Said pivoting fasteners of claim 15 to maintain the position of the elongated diverters by using detents.
